(19) United States
(12) Patent Application Publication
(10) Pub. No.: US 2005/0115586 A1
(43) Pub. Date: Jun. 2, 2005

(54) Method and apparatus for de-inking, cleaning and maintenance of printing presses

(76) Inventors: Jean Lucien Sarda, Paris (FR); Jean-Claude Sarda, Paris (FR)

Correspondence Address: PEACOCK MYERS AND ADAMS P C, P O BOX 26927, ALBUQUERQUE, NM, 871256927, US

(21) Appl. No.: 10/888,607

(22) Filed: Jul. 8, 2004

(30) Foreign Application Priority Data
Dec. 14, 2000 (FR) 0016279

(51) Int. Cl. B08B 7/00

(52) U.S. Cl. 134/6; 134/26; 15/256.51; 101/425

(57) ABSTRACT

The present invention comprises a method and apparatus for cleaning various printing press components. The invention comprises hard and semi-hard scrapers, and allows the use of soft scrapers, to remove printing residues by lamination in conjunction with one or more cleaning agents. The cleaning agents can include gelled and or milky compositions. The gelled cleaning compositions of the present invention reduce or eliminate the emission of volatile organic compounds. The present invention can be used in conjunction with, or instead of, conventional de-inking apparatuses.

### CROSS-REFERENCE TO RELATED APPLICATIONS

This application is a continuation-in-part application of U.S. patent application Ser. No. 10/450,670, entitled “Procedure of De-Inking, Cleaning, and Maintenance of Printing Presses and Apparatus for the Implementation of the Procedure”, to Jean Lucien Sarda and Jean-Claude Sarda, filed on Jun. 13, 2003, which claims priority to PCT/EP01/14710, entitled “Procedure of De-Inking, Cleaning, and Maintenance of Printing Presses and Apparatus for the Implementation of the Procedure”, to Jean Lucien Sarda and Jean-Claude Sarda, filed on Dec. 5, 2001, which claims priority to FR/0016279, entitled “Procedure of De-Inking, Cleaning, and Maintenance of Printing Presses and Apparatus for the Implementation of the Procedure”, to Jean Lucien Sarda and Jean-Claude Sarda, filed on Dec. 14, 2000, and the specifications and claims thereof are incorporated herein by reference.

### BACKGROUND OF THE INVENTION

1. Field of the Invention (Technical Field)

The present invention relates to a method and apparatus for de-inking, cleaning, and maintenance of the various parts of printing presses of all types, regardless of whether printing is done continuously or one sheet at a time. In particular, the present invention relates to de-inking, soaking, offset printing plaques, printing cylinder blankets, counter-pressure cylinders, inkers, and the like. It also relates to the cleaning, including de-inking and maintenance, of all printing components which require the constant elimination of residues such as inks or glazes through either a scraping action or through dispersing them with solvents.

2. Description of Related Art

Printing presses of all types, including offset and typographic presses, are equipped with de-inking devices that work almost entirely by scraping ink residues. Previously, such residues were dissolved. However, their offset printing plaques, as well as their cylinder blankets, counter-pressure cylinders, and inkwells, are cleaned manually with sponges and cloths. The exceptions are high volume production presses that are equipped with automatic washers made for cylinder blankets and counter-pressure cylinders. Those automatic washers, depending on the model, use ink residue extraction tools that work by scraping or, more rarely, by successively dispersing residues with solvents.

Toward the completion of the de-inking operation utilizing automatic devices, a considerable amount of almost pure solvent is distributed and collected by a scraper to extract as much residue as possible. The solvent is mixed with the fluid residues and accumulates in the bottom of a recovery tray. Eventually, the recovery tray becomes very polluted, becomes difficult to move, and care must be taken during cleaning to avoid splattering the liquid residues. The de-inking device is then removed from the printing press and taken elsewhere for cleaning and storage. However, the de-inking device is often used several times before cleaning, because of limited time and/or a desire to avoid a tedious and time consuming cleaning session. The de-inking device typically remains dirty and is placed at the foot of the printing press, from which the solvents begin evaporating. The volatile solvents used during the cleaning process increase the emissions of volatile organic compounds (“VOC's”). These residues are often disposed of with no precautions, or are stored away from exposure to air so that they can be treated later.

Also, the use of such solvents requires careful monitoring by the operator/user to avoid an insufficient distribution of light solvent, which evaporates quickly, the insufficiency of which causes abrasion with the ink table and the instantaneous destruction of the soft scraper.

To overcome these problems, replacing the soft rubber scrapers with plastic scrapers, such as those made of polyamide, has been suggested. Like soft scrapers, the active parts of such harder scrapers work by lamination. For ease of interchangeability, soft scrapers must be able to work by lamination in a quasi-universal fashion with any kind of ink table having a surface that is coated with a film of plastic such as rilsan. Such ink table surfaces have a good coefficient of friction yet a very weak mechanical resistance. This often results, over time, in scratches on their surface, preventing these tables from being mechanically scraped with tough materials that have a sharp scraping edge.

The types of scrapers made of tough plastic material that work by lamination have practically disappeared from the market because they do not offer any significant improvement in performance over the soft scrapers. The ease of interchangeability provided by scrapers that work by lamination, allows the use of all types of ink tables regardless of the nature of their surfaces. Thus, almost all printing presses presently in service, throughout the world, are equipped with lamination scrapers. The advantages provided by these scrapers, however, are offset by serious technical inadequacies and nuisances resulting from their use.

One problem is that the de-inking of printing presses that use lamination scrapers requires the use of light volatile solvents, that in turn leads to glazing. Glazing results from the accumulation and fixing of residual micro particles on the surface and within the surface pores. Glazing quickly removes the properties of homogenization and of the transfer and carrying of the ink film from these rubber surfaces, thus detracting from printing definition. Glazing is difficult to overcome given that every new de-inking operation, averaging about six to ten per day, contributes to the effect.

Also, except for a few modern printing presses that are equipped with automatic distribution means, solvents are manually distributed in a random fashion, thus generating a useless and costly profusion of harmful solvents. Harmful solvents have lead to a need to use light solvents which are necessarily strongly emulsified with water. Their use also results in high rates of VOC emissions, high flammability, and a low rate of bio-degradability. Therefore, the use of de-inking solvents is disproportionate to their mediocre results. The need to render the thick, viscous, and sticky residues soluble and fluid so that scrapers can function via lamination entails, among other inconveniences, an out-flow of liquid waste at each end of the ink rolls and tables. The waste makes de-inking devices difficult to move and clean without the risk of splashing the harmful residues.

Generally, there is little control in the distribution of cleaning solvents. Therefore, there is an excess in their consumption. Fully automating the de-inking function requires a significant and costly amount of de-inking solvents for the evacuation of residues and the rinsing of polluted surfaces. Therefore, this function is unacceptable for almost all printing workshops that do not have the ability to recycle these solvents.

The soaking groups of printing presses, depending on their types, are cleaned manually or automatically, along with the printing inking groups. These methods of de-inking and cleaning use primarily light and volatile solvents such as light essences of hydrocarbons, chlorinated hydrocarbons, aromatic hydrocarbons, kerosene, mixed solvents made of mixtures of esters and aromatic hydrocarbons, and glycol ether solvents derived from ethylene as well as ketones, acetones, cyclohexane or alcohol compositions such as iso-propane methanol, and the like.

All of the light solvents typically used emit volatile organic compounds (“VOC's”) at much higher rates than the ones approved by the International Directives and Norms for substances and preparations. For example, the European Directives for the VOC's approved rate is 0.001 kilogram-Pascal at a temperature of twenty degrees centigrade. Those substances and preparations having a higher VOC's rate are classified as carcinogenic, mutational, or toxic to the reproductive system. With the objective of limiting VOC's that are considered harmful to both humans and the environment, directives for limiting use of these substances are becoming more stringent. Also, given their high rate of flammability, extreme precautions are required in treatment, shipping, and use of the substances.

To address these concerns, oily diluents or solvents that are generally of vegetable origin are offered, and they are usually light oils that comprise emulsifying agents to allow mixing with up to fifty percent water, so that they form an emulsion. The resulting emulsion is typically a mixture of residues of ink, oil, and water, and is less oily than those resulting from mixtures of ink and oil. Scraping this emulsion is not possible using soft scrapers. Although these oily diluents offer advantages compared to de-inking volatile solvents, they are not preferred because they cause major inconveniences derived from their incompatibility with the scraping and distribution tools used in the art.

The scrapers typically used are unable to break and scrape an oily film without leaving a thick oily layer on the rolls and ink tables. Therefore, it is necessary to alternate the distribution of these oils with additives such as water.

There is thus a need for a method and/or apparatus to simplify, rationalize, and automate the cleaning of printing presses.

### BRIEF SUMMARY OF THE INVENTION

The present invention comprises a method of de-inking, cleaning, and performing maintenance on a printing press that comprises providing at least one liquid de-inking, cleaning, and maintenance gelled composition, applying the composition(s) to at least one printing press component, providing a scraper selected form the group consisting of a hard scraper and a semi-hard scraper, and scraping an ink table or an ink roll with the scraper. The residues may be used to thicken the composition(s).

The composition can function as a detergent. The composition can comprise an ingredient selected from the group consisting of oily diluents, soaps, emulsifying agents, emulsifiers, dispersals, soakers, and mixtures thereof. The composition can be gelled at any time and can gelled upon mixing with an ingredient selected from the group consisting of diluents, detergents, water, and mixtures thereof.

The method also comprises evacuating the composition(s) and the residues by rinsing with water or a mixture comprising water or with water mixed with detergent agents.

The method also comprises using a composition comprising an element selected from the group consisting of distilled petroleums, light oils, esters of vegetable origin, esters of synthetic origin, diluting oils, and mixtures thereof. The composition can comprise a milk that can comprise an element selected from the group consisting of diluent detergent emulsions, de-inking diluents, solvents that are liquid and oily, and mixtures thereof.

The method comprises using a scraper comprising a metallic hard scraper. The metallic scraper preferably comprises a scraping edge that is hard, stiff, and flexible with preferably a sharp angle. The metallic scraper can further comprise a material selected from the group consisting of polyethane, polyester, polycarbonate, polypropylene, vinyl polychloride, and mixtures thereof. The scraper can comprise a hard scraper with a hardness of between approximately eighty-five shores D and approximately ninety shores D. The scraper can comprise a semi-hard scraper comprising a scraping edge with an angle of between approximately forty-five degrees and approximately eighty degrees. The scraper can comprise a semi-hard scraper comprising an edge made of elastomeric material. The scraper can comprise a semi-hard scraper comprising an edge with a hardness of approximately eighty shores D. The scraper can comprise a semi-hard scraper comprising an angle of approximately fifteen degrees in relation to an axis of the ink table. The scraper can comprise a semi-hard scraper stiffened up with a metallic frame to between approximately one to approximately three millimeters from the scraping edge of the scraper. The scraper may exert a pre-adjusted pressure against a surface to be scraped. The scraper can comprise a disposable casing which can comprise a bellows. The bellows can have a V shape.

The method can include providing at least one distribution ramp through which the composition(s) flow(s). The flow can be controlled by a component selected from the group consisting of electronic controllers, electromechanical controllers, manual distributor bottles, dosage tools, and mixtures thereof.

The method also provides for a mobile support unit comprising one or more containers for storing the composition(s) or gelling compositions, dosing pumps, tubes for delivering the compositions, and a control desk which may be computerized.

The method also comprises an ink table comprising a surface that comprises a mechanical resistance and a friction coefficient complementary with the use of the scraper. The ink table can also comprise a smooth, non-metallic, hard surface.

The method also comprises providing a tool carrier, disposing a severing tool on the tool carrier, disposing the tool carrier so that the severing tool makes contact with the scraper, and moving the tool carrier so that the severing tool sharpens the scraper.

The invention also comprises a printing press de-inking, cleaning, and maintenance apparatus comprising at least one scraper selected from the group consisting of hard scrapers and semi-hard scrapers, said scraper comprising a sharp scraping edge, at least one distribution ramp for distributing a cleaning or de-inking composition, distribution ramp comprising at least one distribution duct and at least one feeding duct, and at least one pump. The distribution ramp preferably comprises a leak proof joint for joining said the distribution ramp to another distribution ramp. The distribution ramp preferably comprises an out-flowing moderator. The distribution ramp preferably comprises a thickness of approximately 15 millimeters.

The invention also comprises a cleaning and de-inking composition comprising at least one diluent, a detergent agent selected from the group comprising soaps, emulsifying agents, dispersing agents, soaking agents, and mixtures thereof, and an ingredient selected from the group comprising thixotropents, thickeners, gelling agents and mixtures thereof. The composition may further comprise ink residues. The diluent can comprise an oily solvent and/or a vegetable-based diluent. The vegetable-based diluent can comprise a colza methyl ester.

A primary objective of the present invention is to provide for an increased simplification, rationalization, and automation of the cleaning of printing press components.

A primary advantage of the present invention is that compositions that do not emit volatile organic compounds may be used.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a general side view of a conventional printing press of the prior art;

FIG. 2 is a perspective view of a hard scraper of an embodiment of the present invention;

FIG. 3 is a cross-sectional view showing the hard scraper of FIG. 2 in relation to other components of the present invention;

FIG. 4 is a cross-sectional view of another embodiment of a hard scraper shown in relation to other components of the present invention;

FIG. 5 is a cross-sectional view of a semi-hard scraper of an embodiment of the present invention shown in relation to other components of the present invention;

FIG. 6 is a cut-away perspective view of a grinding apparatus of the present invention;

FIG. 7 is a perspective view showing an embodiment of the disposable casing used to cover hard or semi-hard scrapers of the present invention;

FIG. 8 is a perspective view showing another embodiment of the disposable casing used to cover hard or semi-hard scrapers of the present invention;

FIG. 9 is a cross-sectional perspective view of an automatic distribution ramp of the present invention;

FIG. 10 is a perspective view of an automatic distribution ramp of the present invention; and

FIG. 11 is a perspective view of a mobile support of the present invention.

### DETAILED DESCRIPTION OF THE INVENTION

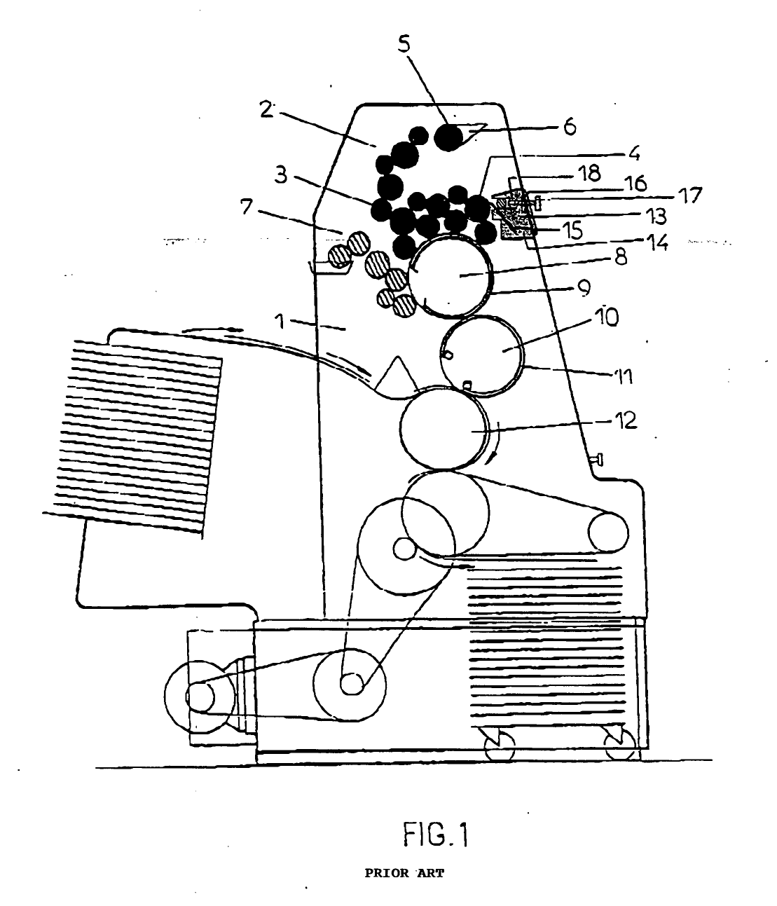

The present invention relates to an apparatus and a method for de-inking, cleaning, and maintenance of various printing press components. FIG. 1 shows a conventional printing press 1 found in the prior art. Within inking group 2 are inking rolls 3, ink tables 4, inkwell ducting cylinder 5, inkwell 6, soaking group 7, cylinder 8 (over which is disposed, in tension, offset printing plaque 9), cylinder blanket carrier 10 (over which is disposed printing blanket 11), counter-pressure cylinder 12 and de-inking apparatus 13. De-inking apparatus 13 typically comprises soft scraper 15 which removes residues. All elements of inking group 2 such as soaking group 7, offset printing plaque 9, printing blanket 11, and counter-pressure cylinder 12 must be serviced and continuously kept clean to provide for the normal use of printing press 1.

Depending on the type of printing press, inking group 2 may have an average of approximately twenty inking rolls 3 in addition to ink tables 4. Inking rolls 3 are typically made of rubber and dragged into rotation through friction by ink tables 4. In addition to their rotational movement, inking rolls 3 perform axial backward and forward movements to grind ink. All elements are generally slightly pressed against each other and function to guide and homogenize an ink film that is extracted from inkwell 6 to provide ink to offset printing plaque 9 at each printing cycle.

De-inking apparatus 13 is attached to printing press 1 through milled buttons 17 disposed on fixing legs 16. Milled buttons 17 are screwed onto threaded linking contacts 18, which are permanently disposed on printing press 1 for this use.

At each de-inking operation, de-inking apparatus 13 of inking group 2 is brought from its stored location and linked, in a working position, to printing press 1. The weak solvent of the residues to be extracted is distributed to all rubber inking rolls 3 and to ink tables 4 before soft scraper 15 is applied in an almost tangential fashion to ink table 4, through the action of milled buttons 17. The purpose of this action is to strongly disperse and oil-off the residues because soft scraper 15, as is typical of soft scrapers, has tender edges which bend and quickly conform to the rounded shapes of ink tables 4.

The “scraping” action performed by soft scraper 15 occurs by lamination at a low pressure and consequently does not extract residues, agents, and other compositions that are oily, lubricative, sticky, gluey, thick, or solid, without leaving a thick film of residues over either scraped ink table 4 or rubber inking rolls 3 and ink tables 4. Such thick films make subsequent inking impossible and thus require prior neutralization. Such neutralization can be achieved by dispersing weak solvents onto the various components of press 1, so that the oily, viscous, and thick ink is sufficiently fluid and can flow over soft scraper 15. It is understood that because “scraping” occurs via lamination, the term “scraping”, when referring to soft scraper 15 does not mean that scraper 15 is exerting a mechanical action to break, detach, and recuperate the residual film in either its natural state or in a slightly diluted state.

As noted above, in the course of scraping, a certain amount of de-inking solvent must frequently be distributed to move and recuperate the residues. Consequently, at the end of the de-inking operation, the residual film remaining on the surface of rolls 3 has a high concentration of solvent and cannot appropriately coat and transfer the fine residual micro-particles because of a lack of internal cohesion and volatility. Also, these solvents evaporate into the atmosphere, leaving the micro-particles of ink strongly fixed to the surface and trapped inside the pores of the rubber surface of rolls 3.

At the beginning of the de-inking operation, the dissolved ink leaks and accumulates on soft scraper 15, which has an angle approximating thirty degrees and is located above the axis of ink table 4 with which it cooperates. As the operator/user re-distributes large amounts of de-inking solvents, the ink residues become more liquid, thus flowing and covering soft scraper 15 and recovering tray 14.

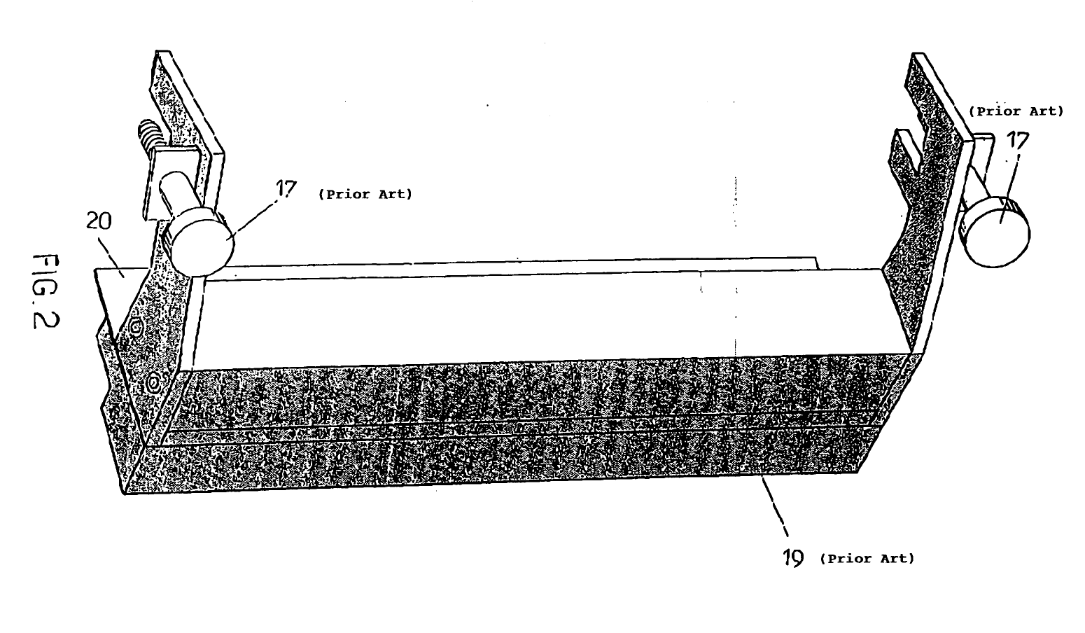

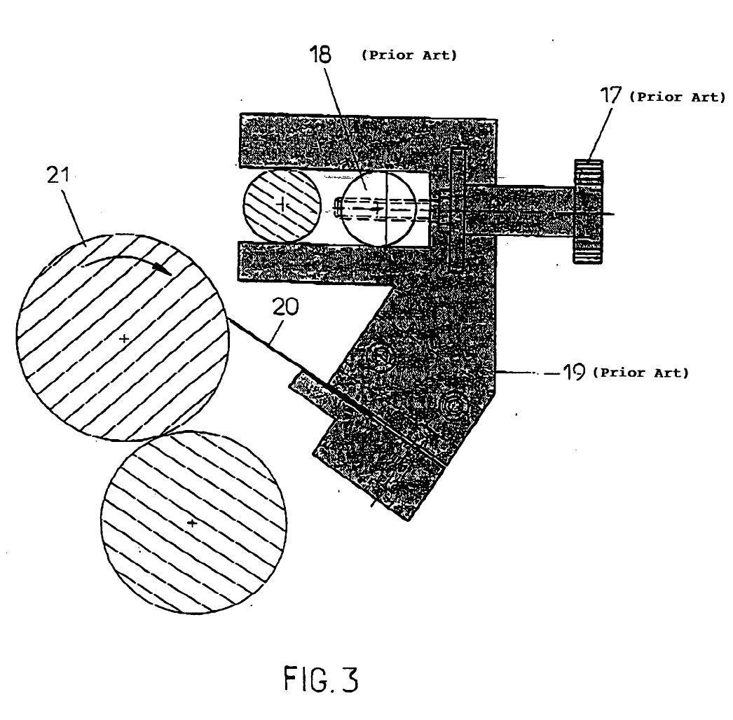

FIG. 2 and FIG. 3 show a scraping device 19 of the prior art equipped with hard metallic scraper 20 of the present invention. In the preferred embodiment, scraper 20 preferably comprises a sharply angled scraping edge and is preferably slightly softened with a plane or rounded surface by a few hundredths of a millimeter and preferably polished with, for example, a polishing pad. Scraper 20 preferably comprises a hard, stiff, and flexible material such as, for example, a metal with a thickness of, on average, a few tenths of a millimeter. Scraper 20 is capable of mechanically breaking and scraping by “cutting” with its sharp, scraping, angled edge. A pre-adjusted light pressure is preferably applied to scraper 20 to assist in the removal of residual films.

FIG. 3 shows that scraper 20 preferably cooperates, in an efficient manner, with ink table 21 which comprises a surface that is adapted for such cooperative use to avoid any damage that might be caused by the mechanical scraping action of scraper 20. Ink table 21 preferably comprises a surface that is finely straightened and smooth, preferably comprises a strong mechanical resistance, and preferably comprises a good friction coefficient so that scraper 20 may act upon ink table 21 without a risk of abnormal wear and tear. Hard scraper 20 preferably comprises a sharply angled scraping edge and preferably comprises a hard material such as, for example, steel. Ink table 21 may comprise steel, thus conferring a surface toughness of approximately sixty Rockwell. The combination of Ink table 21 and scraper 20 optimizes and accelerates the quality and operation of the scraping action, regardless of the compositions or solvents used.

In another embodiment, scraper 20 may comprise a metal such as, for example, a flexible steel with a thickness of approximately two tenths of a millimeter, and can work with ink table 4 if ink table 4 is covered with a rilsan film. In such an embodiment, scraper 20 must have no deep scratches parallel to its axis and preferably comprises a scraping edge that is rounded to work by lamination.

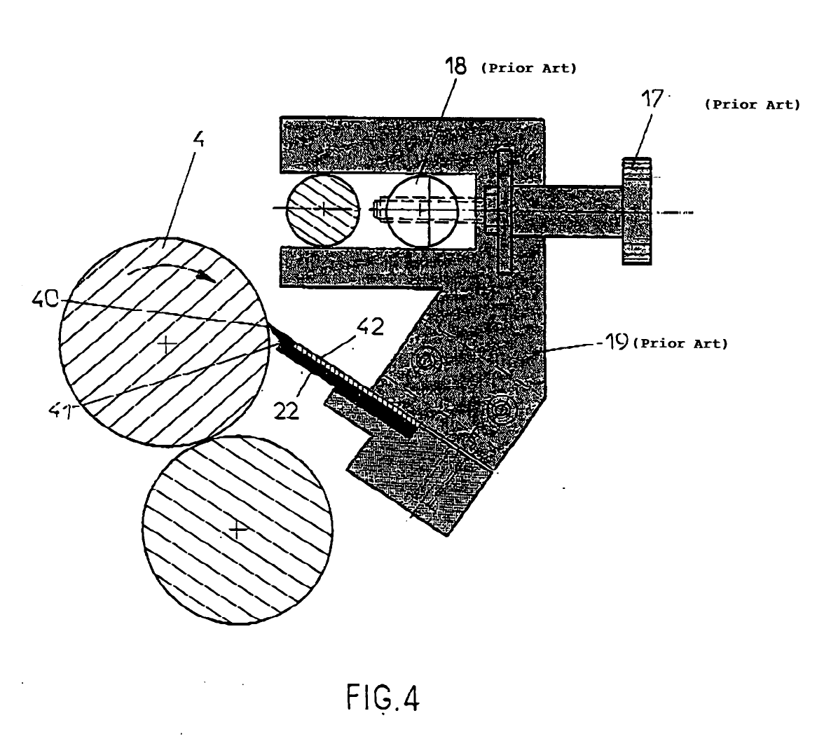

FIG. 4 shows another embodiment of the present invention. Scraping device 19 is equipped with hard scraper 22 comprising sharply angled scraping edge 40 made of a hard, stiff, and flexible material, such as, for example, a hard plastic material. The choice of material is often made based on how scraper 22 is to be manufactured. For example, scraper 22 can be made by molding, stretching, and the like. The material can include, but is not limited to, polyurethane or polyester with a toughness that preferably ranges between eighty five and ninety shores D, or vinyl polychlorure, polycarbonate, polyacetate, polypropylene, and the like. Depending upon the nature of the material used and the attachment of scraper 22 to scraping device 19, the thickness of scraper 22 preferably ranges between two and five millimeters. Hard scraper 22, as in the case of hard metallic scraper 20 can, without having to perform a prior dilution of residues, mechanically break and scrape clean, by cutting, a film of oily printing ink residues. However, hard scraper 22 differs from hard scraper 20 in that scraper 22 can work more efficiently with ink table 4 (when ink table 4 is covered with a rilsan film) tan can than scraper 20.

A primary feature of hard scraper 22 is that the active area in its scraping profile exhibits a stiff yet elastic bending derived, in part, from the variable nature of the material used. The angle, shape, and thickness of scraping edge 40 contributes to the capacity for a stiff yet elastic bending action covering, for example, a few tenths of a millimeter. Thus, hard scraper 22 can bend and absorb, without any abnormal wear and tear, while traversing scratches and defects on the surface of ink table 4.

Profile 41 determines the ability of hard scraper 22 to regularly lose its longitudinal shape, in a stiff and flexible fashion, thus allowing scraper 22, at a previously adjusted measured pressure, to closely fit against ink tables 4 or 21, so that a regular, uniform scraping effect is achieved. The rounded section of profile 41 is very beneficial for obtaining a flexible, very regular bending, while preserving rigidity, because the rounded section regularly spreads the pressure that is exerted by non-bendable scraper 22. The rigidity of scraper 22 can be increased, if necessary, with sheet 42. Sheet 42 preferably comprises steel and preferably comprises a thickness of approximately one millimeter.

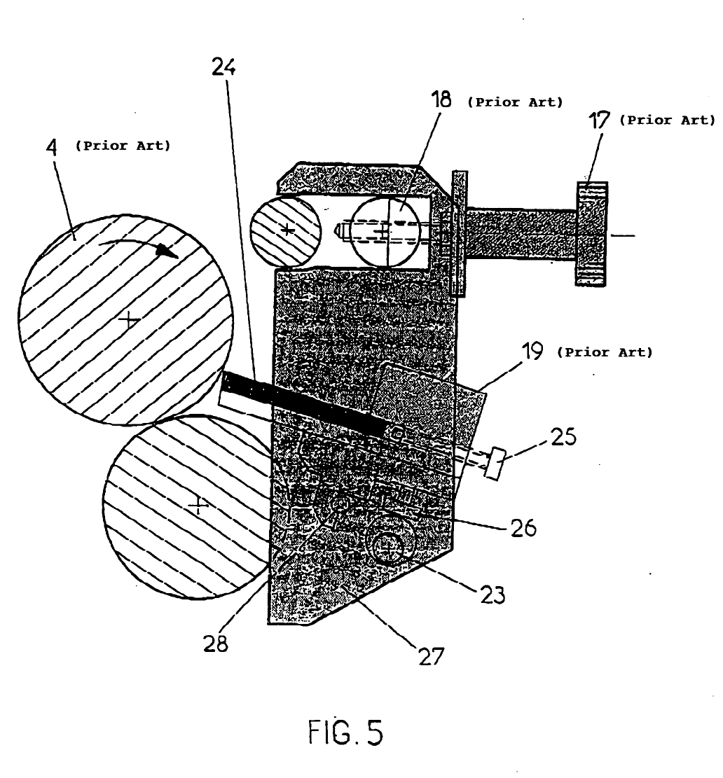

FIG. 5 shows another embodiment wherein scraping device 19 is equipped with semi-hard scraper 24. Scraper 24 preferably comprises a very stiff, sharply angled scraping edge that can, without any abnormal wear and tear, elastically bend as a consequence of the hard elastomers that are preferably utilized. The bending allows semi-hard scraper 24 to cooperate in an efficient manner with ink tables having surfaces with more significant scratches and defects than the surfaces acted upon by hard scraper 22. Scraper 24, or at least the active, scraping portion of scraper 24, is preferably manufactured by molding, extruding, etc. and comprises a material selected from a group of materials that includes, but is not limited to, polyurethane, polyester elastomers, or any other type of material with which a sharp scraping edge that is slightly bendable may be obtained. Semi-hard scraper 24 preferably has a strong mechanical resistance to abrasion and to oily solvent inks. Semi-hard scraper 24 preferably has a degree of toughness ranging from between approximately seventy to approximately eighty shores D.

Semi-hard scraper 24 preferably comprises active scraping portions designed so that they have the rigidity, resistance and mechanical holding along their length so that they can bear and transmit a sufficient pressure that will allow the scraping portions to mechanically break and scrape by cutting. The active, cutting portion of scraper 24 is preferably located, as much as possible, underneath the axis of the ink table 21. This is done to benefit from the lower, round shape of ink tables, and to free the sharp scraping edge, while permitting a stronger increase in the angle so as to provide scraper 24 with a higher rigidity and mechanical holding. The angle can vary from between approximately ninety degrees to approximately forty-five degrees, depending upon the toughness of the active part of scraper 24. The toughness is determined by the location of scraper 24 with respect to the axis of ink table 21 as well as by the degree of damage to the surface if ink table 21. The angle of semi-hard scraper 24 is preferably a minimum of approximately fifteen degrees below the horizontal.

Depending on the available location or space within printing press 1 to be equipped, it sometimes becomes necessary to position the active part of semi-hard scraper 24 above the axle of ink table 4 or 21. This may require, depending on the possible height, length, and angle of semi-hard scraper 24, that the angle of the scraping edge be approximately thirty degrees. Strengthening and increasing the rigidity of scraper 24 up to very close to its active scraping edge (approximately one to three millimeters) can be accomplished with, for example, providing a metallic frame made with a steel sheet and a spring or by over molding the active part of scraper 24. Strengthening by over molding is preferably done with an elastomer of approximately seventy shores D which is further strengthened with an elastomer of approximately ninety shores D. This imparts strong rigidity, toughness, and flexibility to the area of scraper 24 very close to the active edge of scraper 24.

Notwithstanding the lesser toughness of semi-hard scraper 24 in comparison to scrapers 20 and 22, scraper 24 provides some of the advantages of hard scrapers 20 and 22 because scraper 24 can scrape not by lamination but by cutting. Moreover, semi-hard scraper 24 can produce desirable results even with ink tables with mediocre surface condition. Like hard scrapers 20 and 22, semi-hard scraper 24 preferably comprises a polished surface along its scraping edge and is preferably matched with an ink table with which it can cooperate effectively to provide for an efficient scraping faction.

Generally, the greater the sharpness of the angle of a scraping edge, the better the results. Therefore, semi-hard scraper 24, comprising an approximate toughness that ranges from between approximately seventy shores D to approximately eighty shores D and comprising a scraping edge with a sharp angle of approximately ninety degrees, is capable of scraping a substantial amount of offset or similar oily printing ink even if such ink is not previously diluted.

The main advantage offered by semi-hard scraper 24 over hard scrapers 20 and 22 is the ability to of scraper 24 to function with ink tables that are in poor condition. Hard scrapers 20 and 22 as well as semi-hard scraper 24 preferably exert a sufficient minimum pressure in order to perform effectively. This pressure is weighed and previously adjusted while changing the shape, the thickness and the geometry of the scrapers. Weighing and adjusting the pressure prevents excessive pressure that is harmful to effective functioning that can cause abnormal wear and tear to scrapers 20, 22, and 24 and to ink tables 4 and 21.

Because scrapers 20, 22, and 24 work by cutting, they permit the use of liquid, oily lubricants and other de-inking agents without the need to add such additives as water or de-inking, cleaning, and maintenance gelled compositions. At the end of the de-inking operation, only a fine film is left on the surface of rolls and ink tables, and this does not prevent the subsequent inking and helps prevent the fixing of residual micro-particles between each successive printing.

To simplify de-inking, cleaning, and maintenance, devices equipped with scrapers 20, 22, or 24 are preferably disposed in rotation on pins 28 as shown in FIG. 5. Scrapers 20, 22, and 24 are preferably removable with a single motion by, preferably, revolving eccentric axle 23 in such a manner as to release the exerted pressure on pressure adjustment screw 26. Eccentric axle 23 is controllable in a number of ways that will be apparent to those skilled in the art and that can include, but are not limited to, manual, pneumatic, and electro-mechanic means. Adjusting screw 25 may be utilized to position scrapers 20, 22, or 24 (scraper 24 is shown) and to adjust the exerted pressure.

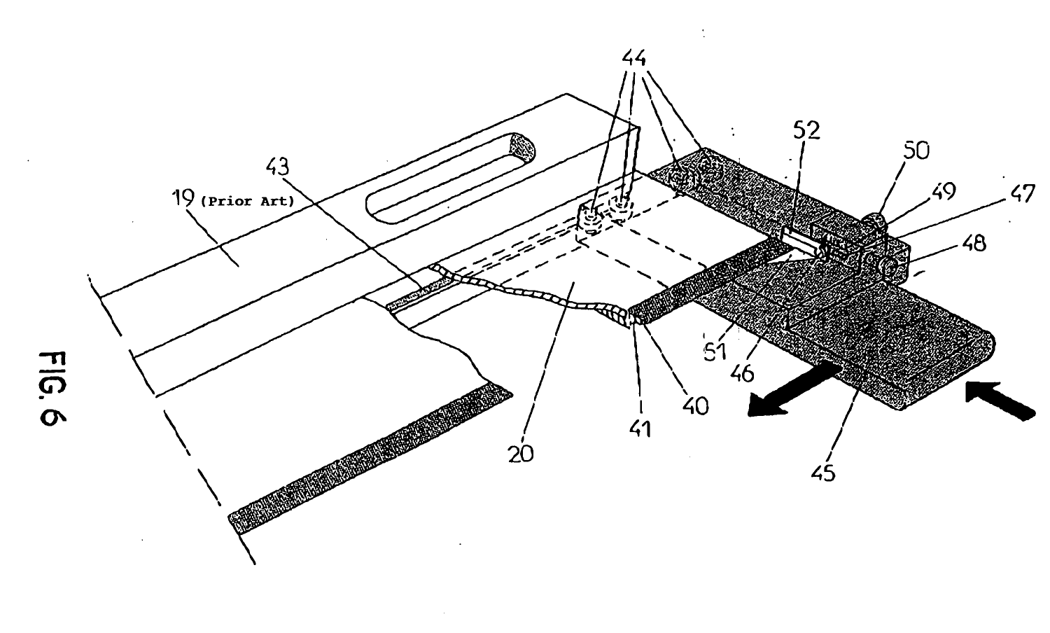

FIG. 6 shows another embodiment of the present invention wherein the scraping edge 40 of scrapers 20, 22, and 24 (scraper 20 is shown) is sharpened so that scrapers 20, 22, and 24 can be used for many years, unlike soft scraper 15 which typically has a life expectancy of only a few weeks. The grinding of the sharp angle of scraping edge 40 is easily made with one motion. Preferably, scraper device 19 comprises guiding grooves 43 on which cart moving wheels 44 of removable tool carrier 45 travel. Cutting tool 46 and sliding inside light 47 are preferably disposed on tool carrier 45. Light 47 is movable via the use of micrometric adjustment screw 48. Screw 48 is preferably attached to vernier 49 which preferably comprises two metallic blades 51, 52. Lower blade 51 is preferably severing, and blade 52 is preferably non-severing. Lower severing blade 51 is preferably positioned at the same angle as scraping edge 40. Non-severing blade 52 is preferably disposed in such a manner that it is slightly leaning over scraper 20, 22, or 24. Blade 52 maintains and pinches scraping edge 40 so as to machine and sharpen scraping edge 40 as tool carrier cart 45 moves along groove 43.

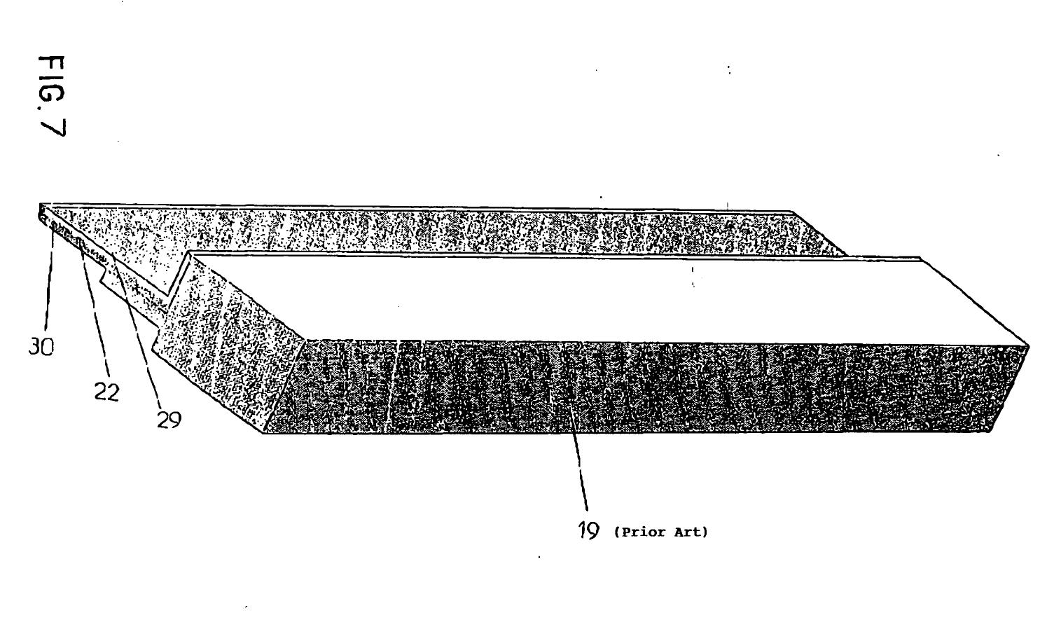

FIG. 7 shows another embodiment of the present invention wherein hard scraper 20, 22, and 24 (scraper 22 is shown) are preferably covered prior to being put to use. The covering preferably accomplished by disposable casing 29 which is retained in place with, preferably, adhesive 30. Disposable casing 29 can be easily detached from scrapers 20, 22, and 24. Disposable casing 29 preferably comprises a material that includes, but is not limited to, a very tight textured paper, a layered paper, and the like. The portion of scraper 20, 22, or 24 that is covered is preferably at most approximately five-tenths of a millimeter. Adhesive 30, set in a gluing zone (not shown) preferably covering a width of approximately ten to fifteen millimeters on the back of disposable casing 29, is preferably replaceable with another means that allows casing 29 to stay in place during cleaning operations. For example, an oily film or a steel sheet can be inserted between disposable casing 29 and scraper 20, 22, or 24, thus pinching an additional crease on disposable casing 29 in an area that would otherwise be held in place with adhesive 30. Disposable casing 29 is preferably very low cost, is preferably adaptable to all types of printing presses 1, is preferably set and removed with a simple motion, is preferably biodegradable, and is preferably easily stored following use pending destruction/disposal.

Thinning out scrapers 20, 22 or 24 very close to its active scraping edge provides the additional possibility of swift residue recovery. For example, disposable casing 29 can be replaced with a removable metallic pot or other container that is easily cleaned outside printing press 1.

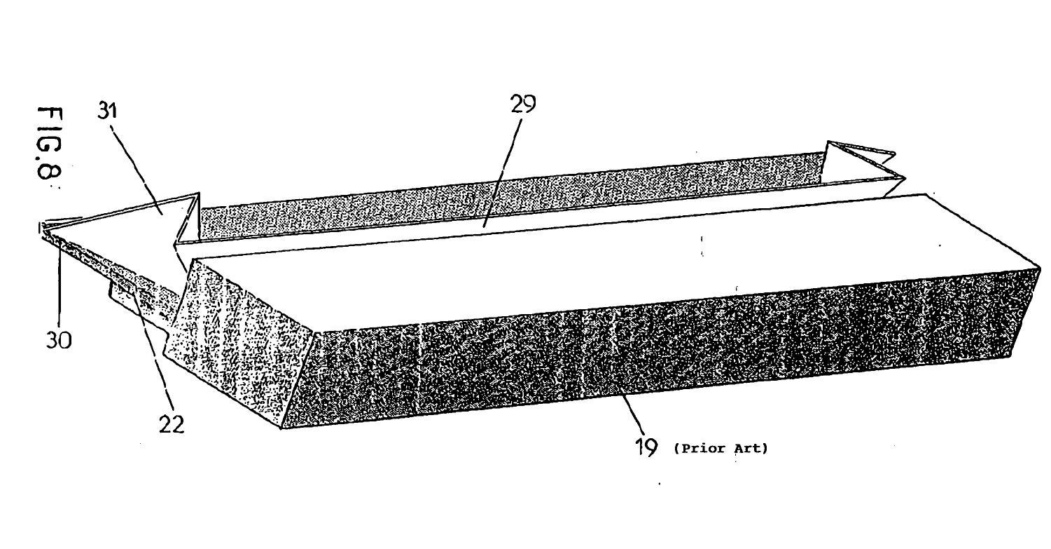

FIG. 8 shows another embodiment wherein disposable casing 29 comprises two bellows 31. In FIG. 8, bellows 31 is depicted as being V-shaped, but virtually any other shape can be utilized to produce desirable results as will be apparent to those skilled in the art. The V-shape, however, can be conveniently obtained by simple folding of the paper sheet or other material. Bellows 31 transform the disposable casing into a pot that is able to contain residues and thus allows for a life expectancy of close to fifteen cleanings before being replaced.

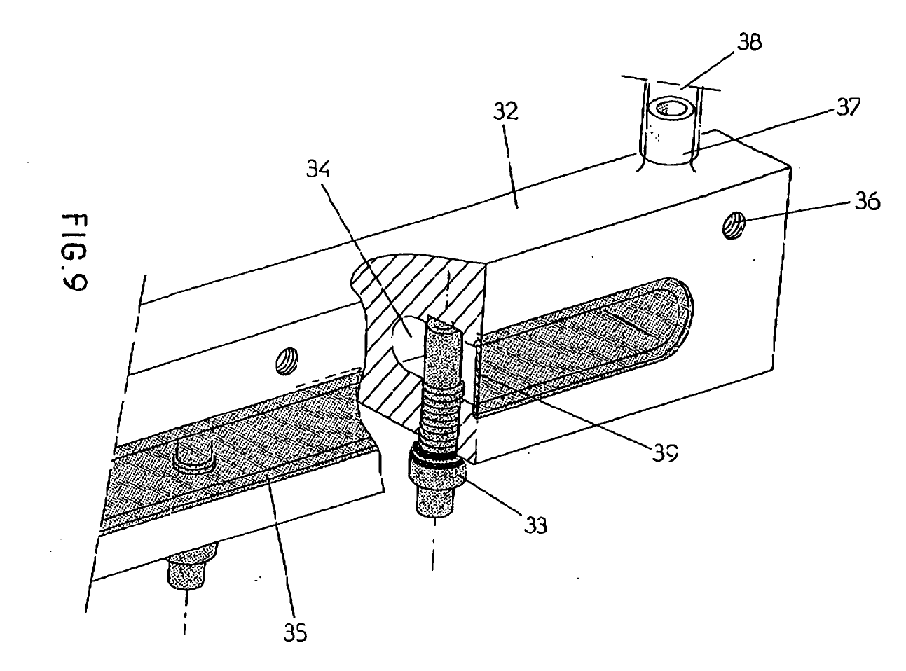

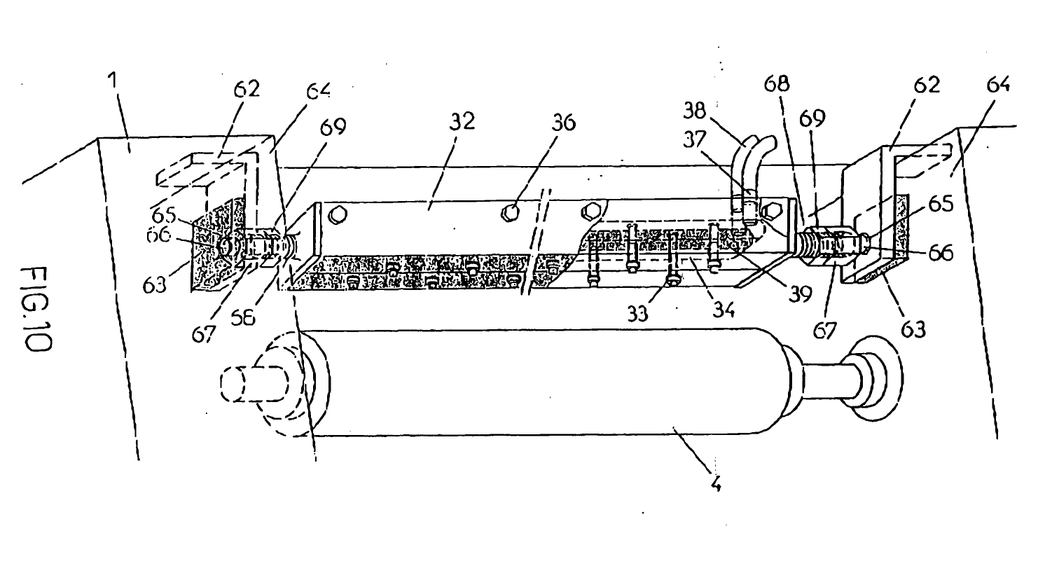

FIGS. 9 and 10 show another embodiment wherein automatic distribution ramp 32 is utilized for the liquid de-inking agents or for the de-inking, cleaning, and maintenance compositions that are gelled. Distribution ramp 32 preferably comprises feeding ducts 34 comprising a very small section, preferably a cross-sectional area of approximately fifteen square millimeters. Distribution ramp 32 preferably comprises distribution ducts 33 which, depending on the viscosity and state of liquids to be treated, are lightly fed above feeding ducts 34 in such a manner as to eliminate, when not in use, any chance of out-flow that is common to ramps of this type. Automatic distribution ramp 32 preferably has a thickness of approximately fifteen millimeters and preferably comprises waterproof/leak proof joint 39 with which ramp 32 may be joined to another ramp 32. Joint 39 is preferably disposed within groove 35. Preferably, screw holes 36 accept screws (not shown) to join ramps 32, but any fastener known in the art may be used to join ramps 32.

Distribution ducts 33 are preferably pierced with holes having a diameter that ranges from between approximately one and a half to approximately three millimeters. An out-flowing moderator of any type commonly known to those skilled in the art is preferably disposed within duct 33 created by this piercing. The moderator can have the shape of a fuse with a previously determined porosity. The porosity is preferably determined based on both the liquid to be treated and the required flow rate. The moderator offers the advantage of eliminating or slowing the filling of distribution duct 33 as well as avoiding the introduction of air into duct 33.

Ramp 32 preferably comprises feeding connection 37 on which pipe 38 is disposed for feeding. Gravity feeding can be performed by either using a manual control, such as a faucet, or by using distribution duct 33. This allows a dosed distribution, the flow of which is previously determined by either changing both the shape and the section of duct 33 or by using small electrical gates that can be connected to various types of controls. The gates provide for distribution ducts 33 to eject, at a low pressure, fine jets that allow a sequential distribution of about one gram of product per linear meter to be emitted with each pulse. Another means of feeding that can be utilized with the present invention is pressure feeding. Pressure can be achieved, for example, through the use of small pumps through which flow and pressure are adjusted to the various types of compositions to be treated and to distribution ducts 33.

Distribution ramps 32 are preferably equipped with quick connection tools so that ramps 32 may be quickly positioned at any location on printing press 1.

FIG. 10 shows an embodiment wherein support angles 62 are disposed at each end of distribution ramp 32 over which is maintained antiskid skate 63. Anti-skid skates 63 lean against each of the two faces of frame 64 of printing press 1. Support angle 62 comprises a positioning hole 65 for distribution ramp 32 in which center post 66 of blocking nut 67 is disposed. Blocking nut 67 operates with threaded rod 68. By unscrewing blocking nuts 67, center posts 66 can be adjusted within positioning holes 65 of support angles 62. Counter-nuts 69 can be used to avoid any accidental wandering of nuts 67.

Because of their easy mechanical function, distribution ramps 32 are of low cost. Distribution ramps 32 allow the use of any solvent, including oily or non-oily diluents, in addition to all kinds of gels, detergents, washing compositions, water, and the like.

Using distribution ramps 32, a strong de-inking action and a thorough cleaning of all elements that make the printing group may be accomplished. This can be accomplished by distributing a simple diluent for general de-inking followed, either simultaneously or alternatively, by a detergent such as soap, thus causing an instantaneous gelling with the diluent to produce a viscous gel. The resulting gel provides a strong cleaning action which can be followed by a simple water rinsing.

Several low cost cleaning actions can be accomplished with distribution ramps 32. Also, distribution ramps 32 can easily integrate into all types of printing press and allow, by their dosed composition distribution, the successful resolution of all problems that occur in the field.

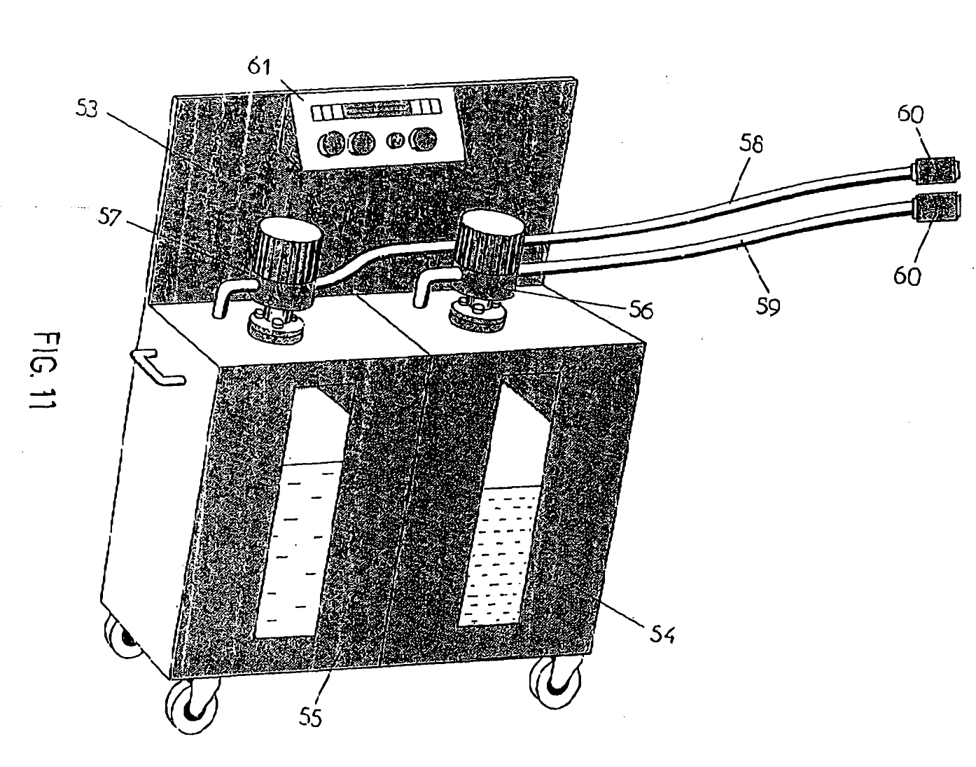

FIG. 11 presents yet another embodiment of the present invention wherein mobile support unit 53 allows the implementation of a set of common cleaning functions for different printing presses and materials, for which time of execution is relatively short with respect to the other printing functions. Mobile support 53 rationalizes and reduces the cost of the cleaning operation. Mobile support unit 53 can comprise one or several storage containers 54 of different agents and compositions and/or water container 55 or added water, respectively equipped with dosing pumps 56 and 57, and feeding tubes 58 and 59 of the distribution and rinsing ramps. Quick connectors 60 are preferably connected in a single motion to the feeding nozzles of the distribution and rinsing ramps. Computerized control desk 61 preferably manages all the de-inking, cleaning, and maintenance functions. Mobile support unit 53 distributes, and can gel, all compositions and agents usable for the cleaning of printer components.

De-inking agents useable with the present invention include, but are not limited to, oily solvents or diluents of vegetable origin that are used without any additive, such as colza methyl ester. They are, by nature, biodegradable, renewable, and of a relatively low risk. These esters are highly important for the present invention whether they are used alone, in combination with other additives to increase their detergent properties, or as a diluent base and later as a gelling agent for products for de-inking, cleaning and maintenance.

The molecules of oily diluents and solvents are preferably combined with the molecules of the oily residues of printing inks thus accelerating their soaking and transfer. This reduces the consumption of these diluents with respect to the light solvents. Their sequential slow dosed distribution allows the residues to absorb these diluents before they are scraped, thus preventing them from being scraped before they have adequately fulfilled their function. The sequential slow dosed distribution results in the economical saving of diluents which would otherwise have been wasted. These de-inking agents can be closely mixed with oily printing residues, by dispersing them while keeping their homogeneity and by giving them a consistency which is not sticky and dry.

Many oilier de-inking agents, such as vegetable diluent oils having no toxicity, are usable with the present invention, and when used with soaps and some detergents, make very good de-inking, cleaning, and maintenance gelled compositions for rubber surfaces.

Except for the simple functions of printing press de-inking where ink is directly reused after scraping, a slight distribution of liquid de-inking agents or de-inking, cleaning, and maintenance gelled compositions prior to scraping is very useful because it allows their elimination from the cleaning apparatus in a much easier manner and does so without the use of any solvent or diluent.

These de-inking liquid agents and de-inking, cleaning, and maintenance gelled compositions, depending on their destination, can also conveniently be given the ability, through this procedure, to scrape oily and consistent compositions. They can also comprise, for example, some regenerating agents for rubber surfaces, as well as some neutralization agents of the minerals contained in the soaking waters that are needed for offset printing. The aforesaid de-inking liquid agents, when used as diluents which comprise little or no additives, reduce costs associated with color printing because they are well adapted to the general de-inking of color printing presses wherein each de-inking group indefinitely preserves its primary printing color and does not require a de-inking and cleaning sufficient to allow switching from a dark color to a light color without having to follow de-inking of the dark color and inking of the light color.

Another advantage of the present invention's ability to use heavy diluents or solvents instead of light solvents is that rubber surfaces do not need to dry as a tiny oily trace remains on the rubber surface and does not impede subsequent inking. This small amount of oil does, however, prevent the fixing, which occurs due to dryness and sedimentation, of the residual micro-particles that make the glazing of the roll surfaces.

The utilization of de-inking, cleaning, and maintenance gelled compositions, even when very light, accentuates the ungluing caused by detergents. The coating and additional mechanical action that results increases the movement of the residual micro-particles, thus preventing their redeposit.

The broad meaning of “gelled” has been herein to describe and characterize the variety of different methods that are complimentary to the cleaning and maintenance methods of the present invention. However, this term also encompasses all substances and compositions of any kind that are able to dilute and clean greasy ink residues, and that are capable of unsticking and trapping residual micro particles while removing excess adhesives. These substances and preparations preferably comprise no VOC's. They exist in any state, from liquid to solid, and are distributed by either gravity or pressure. They also preferably impart a greater viscosity to the ink residues such that the residues are better able to coat them and brake their out-flow, thus providing mechanical detergent properties.

In one embodiment, these substances can be gelled diluent detergents which are usable as such or as gelling agents in the course of the cleaning operation. If the substances are gelling agents, it is preferable that their constituent parts are mixed with milks, which are either non-gelled or gelled very little, such as, for example, diluent detergent emulsions, creams, pastes, foams, and the like.

Within the scope of the present invention, the specific properties that characterize these substances and their detergent gelling mode are of all natures and origins and can, for example, be naturally acquired or can be the result of physio-chemical reactions or the addition of agents such as thixotropent, gelling, thickeners, viscous agents, swelling agents, and the like. These can be used either together or separately. A variety of chemicals selected based upon their nature, cost, obtainability, and the like, can be used to produce detergent milks and gelled substances. These gelled substances can be gelled prior to, or during the course of, the operation.

As explained herein, the set of different gels or diluent detergents is conveniently made of watery detergents because the latter brings, through water rinsing, a physio-chemical repulsion, thus preventing a redeposit of the fixed oily residues on the organic materials such as rubber and rilsan. They also provide a good rinsing and cleaning agent which is cost effective. These various de-inking, cleaning, and maintenance gelled compositions or milks with watery detergent base are also formulated to obtain the evacuation of residues through water rinsing. This allows them, by eliminating the usual solvents for this function, to perform at low cost the entire automatic cleaning by scraping or successive dispersal in a solvent environment of the set of the printing presses elements and must, when used as such, have their watery detergent functions highly strengthened.

The de-inking, cleaning, and maintenance gelled compositions are strengthened enough to sufficiently break down the ink residues and the rinsing water used and to conveniently comprise all types of detergent agents, such as detergents working in combination with gels and milks. The diluents or oily liquid solvents used in the present invention to serve as general liquid de-inking agents or to serve for the making of gels are preferably selected from biodegradable agents that have little or no harmful effects, even if their action is strengthened by using them in association with a cleaning composition working in combination with these oily diluents and solvents. Thus, the use of more active oily solvents or diluents (non-VOC's) is possible through this procedure, including, but not limited to, EDB (ester dibasic), glycol ether, phenoxythanol propanol, and the like. However, despite their strong actions, these oily solvents and diluents do not provide a good cleaning action compared to that resulting from the usage of less harmful solvents or diluents combined with the detergent agents and tools of this invention.

De-inking, cleaning, and maintenance gelled compositions can be distributed through a single source of distribution. For example, they can be distributed by using a single ramp of distribution or a dosing bottle equipped with known dosage tools. In this case, the composition is distributed in its final state where the set of constituents were previously mixed. These de-inking, cleaning, and maintenance gelled compositions are also characterized by their ability to be delivered as concentrated gels or detergents that do not comprise the agents that provoke gelling, when required to be delivered as such. These agents can be, depending on the selected composition, either water or water mixed with additives that strengthen its detergent properties, or also one and/or more diluent detergent agents. In such use, the gel or milk is prepared prior to usage by the user or during the cleaning operation. This is typically done by using the set of rolls or ink tables that belong to the inking group to mix the de-inking and detergent agents to naturally form good quality de-inking, cleaning, and maintenance gelled compositions at the end of the cleaning operation. This type of procedure provides a gel having an adjustable viscosity when needed. This requires two sources of distribution having flows that can be dosed differently, thus offering the advantage of having to distribute only liquid agents having useful lives that are almost unlimited. Having two sources of adjustable distribution also allows the ability to distribute only the general de-inking agent during the de-inking phase. The ability to distribute only the general de-inking agent enables the rapid evacuation of the quantity of residues in an economic fashion, with mechanical scraping tools while using little detergent agent. The cleaning phase can be connected to the de-inking phase by distributing in respectively good proportions the detergent and the diluent. Both diluent and detergent distributions instantaneously provoke detergent gelling or emulsification, thus causing the last residual micro-particles to be unglued, moved, and scraped.

In this example of use, each of the agents used have only one function, which is either diluting or acting as a detergent. Individually, neither function is enough for a good cleaning function. Their combination, however, results in a cleaning which is ten times more effective than either function alone. Successive printings, for example, may use substantially similar tones of color and will thus not require de-inking of the inking group.

The present invention allows a user to use a light oil emulsion, comprising approximately fifty percent water, provided that these compositions have good detergent properties. Under these conditions it is also sufficient to use light oils without water as simple diluents in order to perform the total de-inking function. After de-inking the residual particles can be removed with a small quantity of rinse water that is measured and proportional to the oil distribution, following a last oil distribution. The above procedure, comprising the use of a simple de-inking diluent followed by rinsing with water mixed with a detergent agent that mixes with the diluent, is more practical and less expensive than the use of light oils that comprise emulsifying agents.

This procedure eliminates the need to successively use oil and water and radically changes the use of the oils, thus avoiding risks posed by successive disorganized distributions. These light oils can be used in a more practical and efficient manner than other methods. Although the consumption of light oil will be much higher than with the cleaning apparatuses of the present invention, using the dosed distribution method of the present invention will still greatly reduce the use of VOC's.

Two schematic profiles of the composition of de-inking, cleaning, and maintenance gelled compositions are given as non-limiting examples. In the first example, during the course of the de-inking and cleaning, the gelled or gelling composition is a result of a physio-chemical reaction that creates, through mixing, a stiff and sticky gel. This provides a strong mechanical action of cleaning through ungluing and moving of residual particles. This gel is the result of the combination of a simple de-inking agent and a soap.

Depending upon the gel's intended use, its water solubility can be highly enhanced by changing the proportions of its components in favor of detergent agents and by adding rinse water if necessary. This type of gel allows the various cleaning functions required by the invention to be carried out cost effectively. When used in conjunction with the cleaning apparatuses of the present invention, the gel provides a good de-inking and cleaning of the inking, offset printing plaques, cylinders blankets, and counter pressure cylinders. By rinsing with a simple water or detergent composition, the gel further enables the evacuation of ink residues and, through successive rinsing and dispersal of residues, provides a good cleaning and de-inking of all printing material.

The gel also can result from the combination of a de-inking agent, detergent agents, thixotropent or other agents, and water. Instantaneous mixing triggers the gelling reaction or the thickening of detergent and thixotropent agents used. The gel can be made less reactive by changing its proportions. The less-reactive gel can then be used as a base, providing one of the objectives of the present invention. The two types of gels are chemically similar, and all types of variants can result from the two examples. One can, for example, make de-inking, cleaning, and maintenance compositions in the form of milks that are lightly gelled or non-gelled. These compositions are very efficient for removing oily ink residues. The oily diluents are partially or completely substituted with detergent composition agents such as micronised washing compositions that, when associated with other detergent agents such as soaps or others, provide a strong de-structuring of the oily inks and permit their movement.

When cleaning the cylinder blankets the watery gels eliminate the requirement of having to alternatively distribute water and solvents miscible with water that are made to loosen the fibrous paper particles attached by the oily ink. The gels dilute, coat, and move without making the fibrous residues soluble, thus producing desirable results. Further, because the gelled compositions remain on the surface of the brushes that equip the automatic washers, they do not contaminate the hollows in the cylinder.

The gelled schematic composition can be made of colza ester or a hydrocarbon that is of approximately the same grade. Depending on the required stickiness of the gel, this represents from about forty to about sixty percent of the composition. The composition also comprises from about forty to about sixty percent soap, such as a soap resulting from the chemical reaction of amino over oily acids. The soap itself comprises from about thirty to about sixty percent water. The colza or similar esters can be, by virtue of their relatively low cost, similar to the ones used as bio-carbons in the fuels of diesel engines.

Another example provides a gelled schematic composed of a tension active emulsifier with a high HBL. For example, emulsifiers derived from glucose and associated with a small percent of dispersing, soaking, and detergent agents, such as esters of ethoxylated sorbitols, sugared lipids, laurate methyl and the like can be used. The entire amount of tension active emulsifier preferably represents from about fifteen to about twenty percent of the composition. The composition preferably comprises between about fifty to fifty-five percent oily diluents, such as vegetal ester, distilled petroleum or others, in addition to about twenty to twenty-five percent water and about one to three percent polar solvent.

Depending upon the required gelling and the substances used, it is preferable that from between about three to about ten percent of all types of thixotropent, gelling, and thickening agents, such as organo-bentonite, cracked silica, hydrogenised castor oil, polymer, and the like be used.

About two to three percent of stabilizing and gels preservation agents are preferably included. A user can easily alter the stated proportions of these various constituents in order to obtain gelled compositions or milks adaptable to specific requirements which produce desirable results while remaining within the scope of the present invention.

When these multiple-component gels are produced during the cleaning operation it is preferable that the distribution of each component be made in a sequential pre-established manner in the cleaning cycle.

The present invention can be used in conjunction with, or in place of, the original de-inking apparatuses on all types of printing presses that are already in service or are to be built, regardless of whether printing is done sheet-by-sheet or continuously, and regardless of whether used on a small office press or on a large rotary press.

Where ink residues are extracted by scraping, the objectives of the present invention are based on the use of a set of tools used together or separately, depending on the different cases to be treated. In one embodiment, the primary objective of the present invention is to utilize de-inking liquid agents that come in the form of solvents or diluents, oily or lubricant, or de-inking, cleaning, and maintenance compositions that are gelled. The use of these chemicals enables the removal of any excess stickiness or siccativity, thus resulting in a low rate of emission or even no emission whatsoever of VOC's, in addition to the good properties of biodegradability and generally low harm for both humans and the environment. The present invention also enables the reduction or suppression of risks such as flammability and explosion, as well as the inconvenience of present de-inking solvents, in a manner consistent with the various evolving international recommendations and regulations. Besides limiting the emission of VOC's, these de-inking liquid agents also have the characteristic of being usable in combination with the methods of this procedure, despite their oily and non-volatile state, without any the use of an additive such as water. The de-inking, cleaning, and maintenance compositions that are gelled from a solid to a liquid state, such as a gel or detergent milk, are different and possess more advantages than simple de-inking agents. This is primarily because the gel has a diluting and residue moving ability. This is also because they comprise, in addition to dilution agents, detergent agents which greatly enhance the movement of residues. Because they are gels, all of these functions can be accomplished while simultaneously avoiding any redeposit.

Other significant advantages of the present invention include eliminating the use of volatile de-inking solvents which cause strong emissions of VOC's, reducing the consumption of liquid de-inking agents, and reducing the consumption of cleaning and maintenance compositions that are gelled by using efficient distribution techniques, thus allowing them to dose, measure, and distribute, in correct proportions. Yet another advantage of the present invention is the use of the residues as thickening substances of the de-inking liquid agents. This is done by distributing these agents in small dosed quantities during the course of the cleaning operation, thus bringing a strong reduction in their consumption and allowing the residues to preserve enough consistency to avoid any parasitic out-flow from the edges of the rubbery ink table and rolls. This is done while limiting any infiltration and fixing of their micro-particles inside the pores of the rubbery surfaces.

Still further advantages of the present invention include cost effective complete or partial automation of the cleaning function, automatic cleaning of the entire printing group by simultaneously cleaning the various elements of the printing group, and the saving of time by simplifying the cleaning of the cleaning apparatuses following usage. Advantages of the present invention are further enhanced by covering the surfaces of these cleaning apparatuses with a disposable casing.

The present invention also eliminates the necessity to make substantially fluid the residues during the general de-inking operation in order to keep a relatively low rate of out flowing, such that residues can be recovered in a semi-fluid state while allowing them to slowly out flow during the scraping operation. The present invention allows the modification of the state of the oily printing ink residues, by eliminating their stickiness and siccativity, in order to allow these consistent residues to easily leave the various parts of the cleaning apparatuses in a manner that allows for their easy removal without the need for any additional solvents or diluents. The present invention eliminates the risk of soiling and splashing which usually occurs during the shipping and the cleaning of de-inking apparatuses that comprise highly fluid residues. The present invention significantly reduces and rationalizes the functions of de-inking and cleaning while significantly reducing the cost of such functions and provides for partial de-inking in order to recover ink, by directly scraping it without any previous dilution, at close to eighty percent ink, depending on the scraping capability of the scraper. The present invention significantly enlarges the range of basic compositions used as de-inking liquid agents or used to formulate the de-inking, cleaning, and maintenance gelled compositions, thus resulting in price reduction as well as an increase in the number of sources of supply.

The present invention also allows for preservation and utilization of the original ink tables of existing presses, thus enabling them to function along with cleaning apparatuses of the present invention; allows full or partial replacement of all types of existing de-inking apparatuses with those of the present invention, for all types of printing presses in service, including sheet by sheet and continuous feed presses; and allows the replacement of de-inking apparatuses which are difficult to access during cleaning with de-inking apparatuses which are easily accessed.

The present invention can eliminate the use of VOC's because it uses scrapers which are able to remove materials that are as viscous, oily, and consistent, such as oily printing ink. These scrapers use gelled products that are more or less oily, have a wide range of possible viscosities, and do not emit VOC's.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. A method of de-inking, cleaning, and performing maintenance on a printing press comprising the steps of:
providing at least one liquid de-inking, cleaning, and maintenance gelled composition;
applying the at least one composition to at least one printing press component;
providing a scraper selected form the group consisting of a hard scraper and a semi-hard scraper; and
scraping an ink table or an ink roll with the scraper.

2. The method of claim 1 further comprising the step of using residues to thicken the at least one composition.

3. The method of claim 1 wherein the at least one gelled composition functions as a detergent.

4. The method of claim 3, wherein the at least one composition comprises an ingredient selected from the group consisting of oily diluents, soaps, emulsifying agents, emulsifiers, dispersals, soakers, and mixtures thereof.

5. The method claim 1 wherein the at least one composition is gelled at any time.

6. The method of claim 5 wherein the at least one composition is gelled upon mixing with an ingredient selected from the group consisting of diluents, detergents, water, and mixtures thereof.

7. The method of claim 1 further comprising the step of evacuating the at least one composition and the residues by rinsing with water or a mixture comprising water.

8. The method of claim 1 further comprising the step of evacuating the at least one composition and the residues by rinsing with water mixed with detergent agents.

9. The method of claim 1 wherein the at least one composition comprises an element selected from the group consisting of distilled petroleums, light oils, esters of vegetable origin, esters of synthetic origin, diluting oils, and mixtures thereof.

10. The method of claim 1 wherein the at least one composition comprises a milk.

11. The method of claim 10 wherein the milk comprises an element selected from the group consisting of diluent detergent emulsions, de-inking diluents, solvents that are liquid and oily, and mixtures thereof.

12. The method of claim 1 wherein the scraper comprises a metallic hard scraper.

13. The method of claim 12 wherein the metallic scraper comprises a scraping edge that is hard, stiff, and flexible.

14. The method of claim 12 wherein the metallic scraper comprises a scraping edge comprising a sharp angle.

15. The method of claim 12 wherein the metallic scraper further comprises a material selected from the group consisting of polyethane, polyester, polycarbonate, polypropylene, vinyl polychloride, and mixtures thereof.

16. The method of claim 1 wherein the scraper comprises a hard scraper with a hardness of between approximately eighty-five shores D and approximately ninety shores D.

17. The method of claim 1 wherein the scraper comprises a semi-hard scraper comprising a scraping edge with an angle of between approximately forty-five degrees and approximately eighty degrees.

18. The method of claim 1 wherein the scraper comprises a semi-hard scraper comprising an edge comprising an elastomeric material.

19. The method of claim 1 wherein the scraper comprises a semi-hard scraper comprising an edge with a hardness of approximately eighty shores D.

20. The method of claim 1 wherein the scraper comprises a semi-hard scraper comprising an angle of approximately fifteen degrees in relation to an axis of the ink table.

21. The method of claim 1 wherein the scraper comprises a semi-hard scraper stiffened up with a metallic frame to between approximately one to approximately three millimeters from the scraping edge of the scraper.

22. The method of claim 1 further comprising the step of providing that the scraper exerts a pre-adjusted pressure against a surface to be scraped.

23. The method of claim 1 wherein the scraper comprises a disposable casing.

24. The method of claim 23 wherein the disposable casing comprises a bellows.

25. The method of claim 24 wherein the bellows comprises a V shape.

26. The method of claim 1 further comprising the step of providing at least one distribution ramp through which that at least one composition flows.

27. The method of claim 26 wherein the flow of the at least one composition is controlled by a component selected from the group consisting of electronic controllers, electromechanical controllers, manual distributor bottles, dosage tools, and mixtures thereof.

28. The method of claim 1 further comprising the step of providing a mobile support unit comprising one or more containers for storing the at least one composition or gelling compositions, dosing pumps, tubes for delivering the compositions, and a control desk.

29. The method of claim 28 wherein the control desk is computerized.

30. The method of claim 1 wherein the ink table comprises a surface that comprises a mechanical resistance and a friction coefficient complementary with the use of the scraper.

31. The method of claim 1 further comprising the step of providing the ink table with a smooth, non-metallic, hard surface.

32. The method of claim 1 further comprising the steps of:
providing a tool carrier;
disposing a severing tool on the tool carrier;
disposing the tool carrier so that the severing tool makes contact with the scraper; and
moving the tool carrier so that the severing tool sharpens the scraper.

33. A printing press de-inking, cleaning, and maintenance apparatus comprising:
at least one scraper selected from the group consisting of hard scrapers and semi-hard scrapers, said scraper comprising a sharp scraping edge;
at least one distribution ramp for distributing a cleaning or de-inking composition, said at least one distribution ramp comprising at least one distribution duct and at least one feeding duct; and
at least one pump.

34. The apparatus of claim 33, said at least one distribution ramp comprising a leak proof joint for joining said at least one distribution ramp to another said distribution ramp.

35. The apparatus of claim 33, said at least one distribution ramp comprising an out-flowing moderator.

36. The apparatus of claim 33, said at least one distribution ramp comprising a thickness of approximately 15 millimeters.

37. A cleaning and de-inking composition comprising:
at least one diluent;
a detergent agent selected from the group comprising soaps, emulsifying agents, dispersing agents, soaking agents, and mixtures thereof; and
an ingredient selected from the group comprising thixotropents, thickeners, gelling agents and mixtures thereof.

38. The composition of claim 37 further comprising ink residues.

39. The composition of claim 37, said at least one diluent comprising an oily solvent.

40. The composition of claim 37, said diluent comprising a vegetable-based diluent.

41. The composition of claim 40, said vegetable-based diluent comprising a colza methyl ester.

42. An apparatus for de-inking, cleaning, and performing maintenance on a printing press comprising:
at least one liquid de-inking, cleaning, and maintenance gelled composition;
and at least one scraper selected form the group consisting of a hard scraper and a semi-hard scraper.

43. The apparatus of claim 42, said at least one composition comprising a detergent.

44. The apparatus of claim 42, said at least one composition comprising an ingredient selected from the group consisting of oily diluents, soaps, emulsifying agents, emulsifiers, dispersals, soakers, and mixtures thereof.

45. The apparatus of claim 42, said at least one composition comprising an element selected from the group consisting of distilled petroleums, light oils, esters of vegetable origin, esters of synthetic origin, diluting oils, and mixtures thereof.

46. The apparatus of claim 42, said at least one composition comprising a milk.

47. The apparatus of claim 46, said milk comprising an element selected from the group consisting of diluent detergent emulsions, de-inking diluents, solvents that are liquid and oily, and mixtures thereof.

48. The apparatus of claim 42, said at least one scraper comprising a metallic hard scraper.

49. The apparatus of claim 42, said at least one scraper comprising a metallic scraper comprising a scraping edge that is hard, stiff, and flexible.

50. The apparatus of claim 42, said at least one scraper comprising a metallic scraper comprising a scraping edge, and said edge comprising a sharp angle.

51. The apparatus of claim 42, said at least one scraper comprising a metallic scraper further comprising a material selected from the group consisting of polyethane, polyester, polycarbonate, polypropylene, vinyl polychloride, and mixtures thereof.

52. The apparatus of claim 42, said at least one scraper comprising a hard scraper with a hardness of between approximately eighty-five shores D and approximately ninety shores D.

53. The apparatus of claim 42, said at least one scraper comprising a semi-hard scraper comprising a scraping edge with an angle of between approximately forty-five degrees and approximately eighty degrees.

54. The apparatus of claim 42, said at least one scraper comprising a semi-hard scraper comprising an edge made, and said edge comprising an elastomeric material.

55. The apparatus of claim 42, said at least one scraper comprising a semi-hard scraper comprising an edge with a hardness of approximately eighty shores D.

56. The apparatus of claim 42, said at least one scraper comprising a semi-hard scraper comprising an angle of approximately fifteen degrees in relation to an axis of an ink table.

57. The apparatus of claim 42, said at least one scraper comprising a semi-hard scraper stiffened up with a metallic frame to between approximately one to approximately three millimeters from the scraping edge of said scraper.

58. The apparatus of claim 42 further comprising an ink table comprising a surface with a mechanical resistance and a friction coefficient complementary with the use of said at least one scraper.

59. The apparatus of claim 42 further comprising an ink table with a smooth, non-metallic, hard surface.

60. The apparatus of claim 42, said at least one scraper comprising a disposable casing.

61. The apparatus of claim 42, said disposable casing comprising a bellows.

62. The apparatus of claim 42, said bellows comprising a V shape.

63. The apparatus of claim 42 further comprising at least one distribution ramp through which that at least one composition flows.

64. The apparatus of claim 42 further comprising a component selected from the group consisting of electronic controllers, electromechanical controllers, manual distributor bottles, dosage tools, and mixtures thereof.

65. The apparatus of claim 42 further comprising a mobile support unit comprising one or more containers for storing said at least one composition or a gelling composition, dosing pumps, tubes for delivering said at least one composition or said gelling composition, and a control desk.

66. The apparatus of claim 42, said control desk comprising a computerized control desk.

67. The apparatus of claim 42 further comprising at least one severing tool disposed on each of at least one tool carrier, said at least one tool carrier disposed on each of said at least one scraper so that said at least one severing tool makes contact with each of said at least one scraper.
